(19) United States
(12) Patent Application Publication
(10) Pub. No.: US 2013/0218836 A1
(43) Pub. Date: Aug. 22, 2013

(54) Deep Linking From Task List Based on Intent

(71) Applicants: Anne K. Sullivan, San Francisco, CA (US); Lisa Stifelman, Palo Alto, CA (US); Kathy Lee, San Francisco, CA (US); Matt Klee, Lynnfield, MA (US); Larry Paul Heck, Los Altos, CA (US); Gokhan Tur, Fremont, CA (US); Dilek Hakkani-Tur, Fremont, CA (US)

(72) Inventors: Anne K. Sullivan, San Francisco, CA (US); Lisa Stifelman, Palo Alto, CA (US); Kathy Lee, San Francisco, CA (US); Matt Klee, Lynnfield, MA (US); Larry Paul Heck, Los Altos, CA (US); Gokhan Tur, Fremont, CA (US); Dilek Hakkani-Tur, Fremont, CA (US)

(73) Assignee: MICROSOFT CORPORATION, Redmond, WA (US)

(21) Appl. No.: 13/401,876

(22) Filed: Feb. 22, 2012

(51) Int. Cl. G06F 7/00; G06F 17/30

(52) U.S. Cl. 707/613; 707/755; 707/756; 707/E17.044; 707/E17.005

(57) ABSTRACT

Task list linking may be provided. Upon receiving an input from a user, the input may be translated into at least one actionable item. The at least one actionable item may be linked to a data source and displayed to the user.

### BACKGROUND

Task list linking may be provided. Tasks or to do items often come to mind when a user is not able to actually act on them. For example, a user may remember that they need to order a gift for a friend while driving, but not be able to order it right then and there. Conventional systems may allow users to make notes about tasks to be accomplished later, but the notes may not have enough detail to fully remind the user of their original goal. For example, when they are able to act on it, the items that have been entered are just static text strings, requiring the user to re-enter information that may have already been provided to some other application or in some other form.

### SUMMARY

This Summary is provided to introduce a selection of concepts in a simplified form that are further described below in the Detailed Description. This Summary is not intended to identify key features or essential features of the claimed subject matter. Neither is this Summary intended to be used to limit the claimed subject matter's scope.

Task list linking may be provided. Upon receiving an input from a user, the input may be translated into at least one actionable item. The at least one actionable item may be linked to a data source and displayed to the user.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of an operating environment;

FIG. 2 is a flow chart of a method for providing task list linking; and

FIG. 3 is a block diagram of a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention.

Task list linking may be provided. For example, users may quickly capture a thought or to do item, such as via voice or text input, which may be added to a task list. User inputs may be analyzed to understand what task(s) the user is trying to accomplish and help them get the task(s) done. The captured input may be parsed through an understanding engine and actionable elements may be presented to the user in a way to aid in accomplishing the user's task, such as by hyperlinking certain terms, providing a list of suggested next actions, opening another application using relevant details from the input. For example, saying “order the Hunger Games for Leah” may be parsed such that selecting “order the Hunger Games” would be linked to a place where that book can be ordered, and selecting “Leah” may call her or link to her contact information with her address to make it easier to complete the task. In another example, selecting ‘Home Depot’ in the task “pick up paint at Home Depot” could display a list of locations near the user. Things that might be hyperlinked may include, but are not limited to, people, places and things.

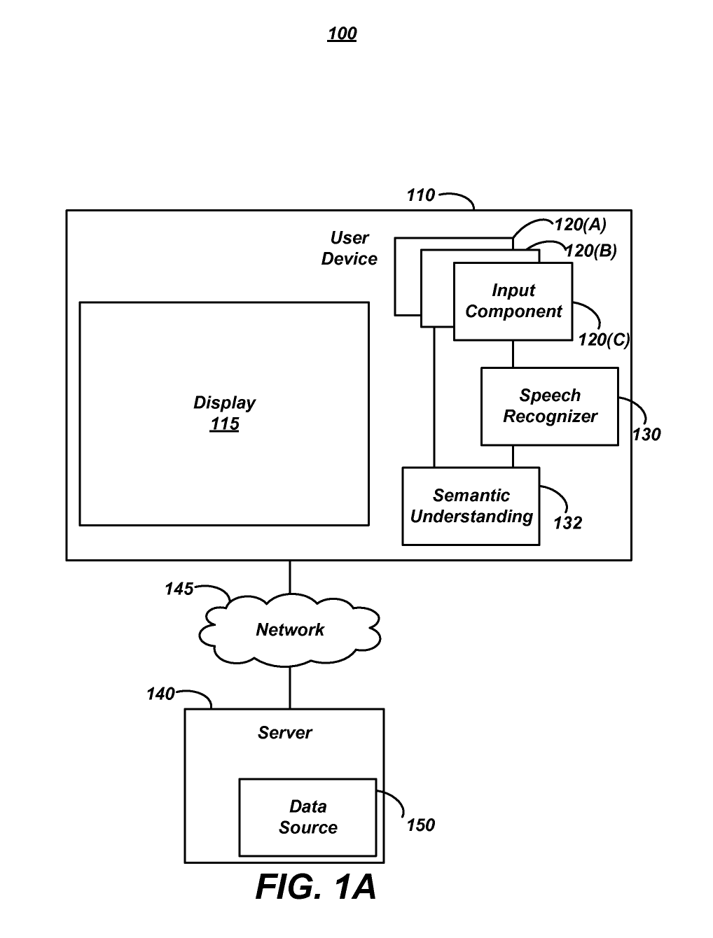

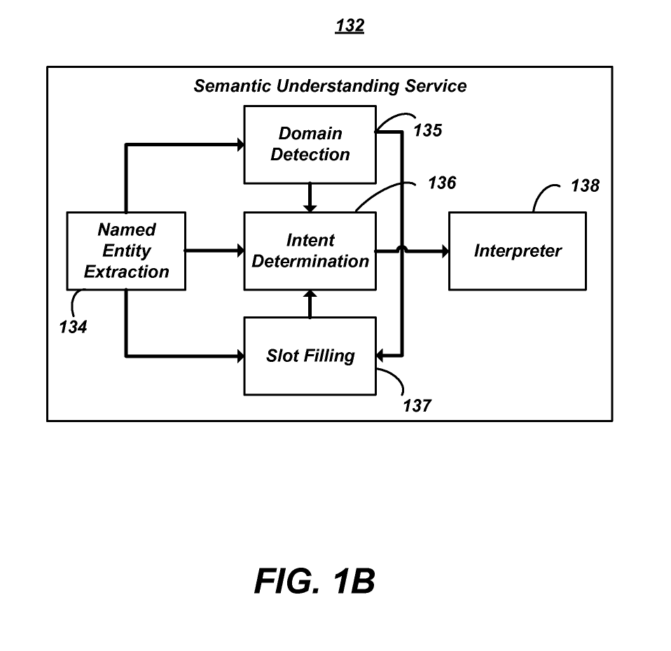

Each user input may be parsed for semantic understanding. Named entities and semantic slots in the input may be identified for a target domain, a set of actions may be identified for each of those semantic slots, and an overall intent of the user may be determined using the entities, slots, and the words in the input in context as depicted below in FIGS. 1A and 1B. For example, a user may input “Book a table at a That place for dinner Saturday night with Matt.” The semantic slots “dinner”, “That”, and “Saturday night” may be identified and then interpreted in context. The overall intent may be determined to be to make reservations for dinner. Actions that serve this intent may be suggested, such as providing a list of nearby restaurants with reservations available at the desired time, sharing suggestions and/or an invitation with Matt, booking the reservations, and/or providing directions to a selected restaurant.

The underlying technology may comprise services, applications, components and/or software that may perform natural language understanding. The understanding service may identify the domain (e.g., books), the intent (e.g., buy) and/or the specific slots (e.g., book title) associated with each item. The understanding service may then provide links for each of the named entities for an item (as in the above example, where “home depot” links to a display of their locations and/or their website). Further, the understanding service may understand the full intent and allow the user to execute the task. For example, for an item “Remember to schedule a meeting with William” the intent may be to “schedule a meeting” and the attendees are going to be the user and a contact named “William”. When the user chooses to execute this task, a deep link to the calendar may be created and the meeting may be set up (e.g., by bringing up a calendar widget with the attendees filled out, a list of times that all attendees are available, and/or a link to available conference rooms that may be reserved).

FIG. 1A is a block diagram of an operating environment 100 for providing task list linking comprising a user device 110. User device 110 may comprise a display 115 operative to output application data and/or user interfaces, such as a monitor and/or touchscreen. User device 110 may comprise, for example, an electronic communications device such as a computer, laptop, cellular and/or IP phone, tablet, game console and/or other device. User device 110 may also comprise a plurality of input mode components 120(A)-(C) such as a keyboard input mode component and/or a microphone coupled to a speech input mode component. The speech input mode component (e.g., input mode component 120(A)) may provide audio inputs to a speech recognizer 130 for conversion into a text format and content analysis by a semantic understanding service 132. Text inputs, such as may be captured by input component 120(B), may be provided directly to semantic understanding 132. User device 110 may be operative to communicate with other devices such as server 140 via a network 145. Server 140 may be operative to provide data to user device 110 from a data source 150. Network 145 may comprise, for example, a public network such as the Internet, a wired network, a wireless network, and/or a cellular network.

FIG. 1B is a block diagram of semantic understanding service 132 as depicted in FIG. 1A. Semantic understanding service may receive inputs from input mode components 120(A)-(C) and/or speech recognizer 130 and process those inputs using a named entity extraction component 134. The processed input may then be provided to a domain detection component 135, an intent determination component 136 and/or a slot filling component 137. These components may operate jointly and/or asynchronously to provide named entities, a target domain, filled semantic slots, and/or a user intent to an interpreter component 138 that may output a set of actions associated with accomplishing the user intent.

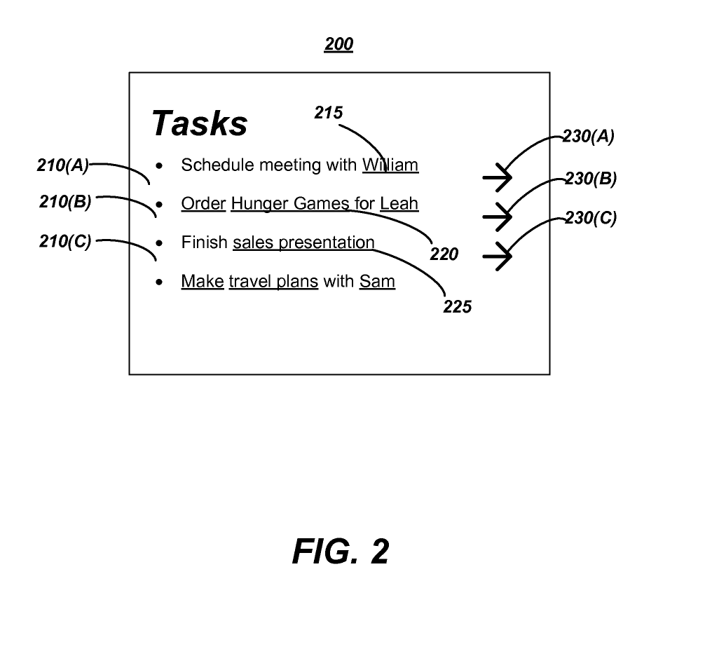

FIG. 2 is a diagram of an example user interface 200 comprising a plurality of task items 210(A)-(C). Each task item 210(A)-(C) may comprise a reminder to a user of some action the user may want and/or need to accomplish. For example, task item 210(A) may comprise a reminder to schedule a meeting with a co-worker. Each of task items 210(A)-(C) may comprise a property that may be linked to a data source. For example, task item 210(A) may comprise a contact property 215 that may link to a user's address book, task item 210(B) may comprise a web data property 220 that may comprise a hyperlink to a webpage, such as a book ordering website, and task item 210(C) may comprise a file property 225 that may link to a file the user may be working on. User interface 200 may further comprise a plurality of action elements 230(A)-(C), each associated with one of task items 210(A)-(C). Action elements 230(A)-(C) may be selectable user interface elements that may execute other applications, software routines, and/or modules associated with user device 110. For example, selection of action element 230(A) may execute an appointment builder software widget, while selection of action element 230(C) may launch a presentation application.

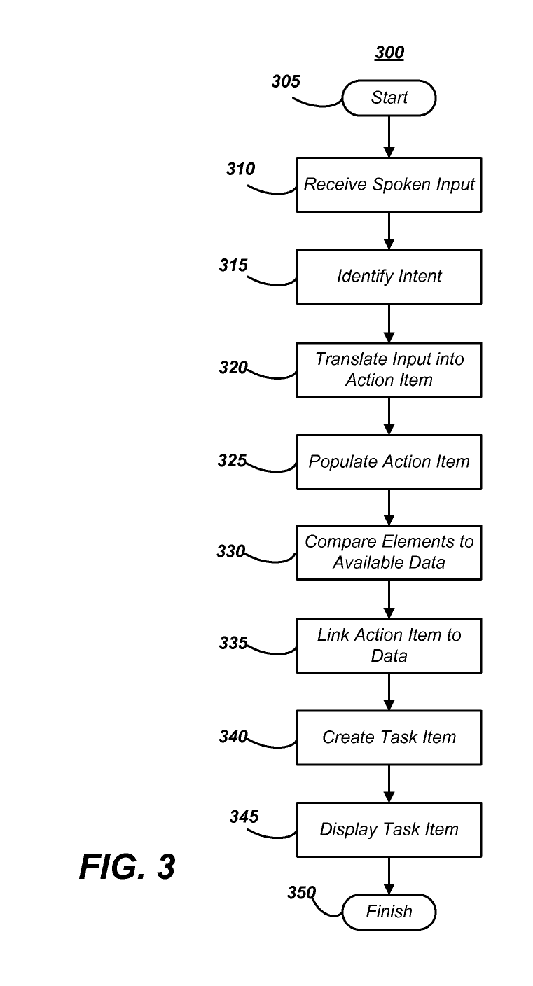

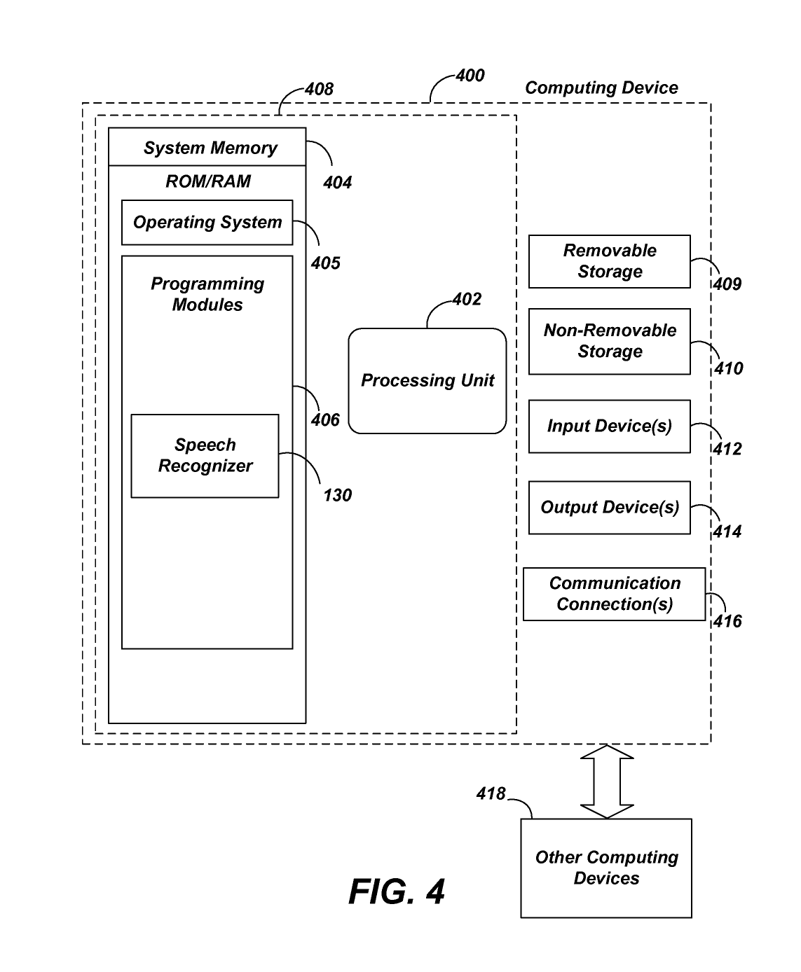

FIG. 3 is a flow chart setting forth the general stages involved in a method 300 consistent with an embodiment of the invention for providing task list linking. Method 300 may be implemented using a computing device 400 as described in more detail below with respect to FIG. 4. Ways to implement the stages of method 300 will be described in greater detail below. Method 300 may begin at starting block 305 and proceed to stage 310 where computing device 400 may receive a spoken input from a user associated with a user device. For example, the user may say “I need to set up a meeting with William.” The speech may be received by input component 120(C) comprising a microphone on user device 110.

Method 300 may then advance to stage 315 where computing device 400 may identify an intent associated with the spoken input. For example, the spoken input may be provided to speech recognizer 130 and semantic understanding service 132 for analysis. Semantic understanding service 132 may perform a semantic parse of the spoken input to identify an intent domain associated with the spoken input. The domain may comprise a plurality of semantic slots. For example, for the input “I need to set up a meeting with William,” speech understanding service may identify the intent as scheduling a meeting in the calendar appointment domain. The calendar appointment domain may comprise semantic slots such as attendees, time, date, subject, etc.

Method 300 may then advance to stage 320 where computing device 400 may translate the input into at least one actionable item associated with the identified intent. For example, for the input “I need to set up a meeting with William,” a reminder item may be created comprising a link to an appointment builder widget. The item may comprise elements such as a subject and/or any semantic slots identified by speech recognizer 130. Such a widget may connect to data source 150 to identify times on the user's and William's calendars that are available for the meeting.

Method 300 may then advance to stage 325 where computing device 400 may populate at least one first element of the plurality of elements of the at least one actionable item according to the identified at least one semantic slot. For example, the input entity “William” may be mapped to a contact “William Smith” known to the user and the reminder item may have an attendee element populated with “William Smith.”

Method 300 may then advance to stage 330 where computing device 400 may compare each of the plurality of elements of the input to each of a plurality of properties associated with a plurality of external data sources. For example, the element “William” may be compared to items in data sources on user device 110, such as entries in the user's contact list. Elements may also be compared to available data in data sources external to user device 110, such as data source 150 provided by server 140.

Method 300 may then advance to stage 335 where computing device 400 may link an element of the actionable item to one of the properties associated with the data sources. For example, a hyperlink may be associated with one of the elements that may connect to data such as a network data source, a user profile, a website, a contact, an address, and/or a meeting event.

Method 300 may then advance to stage 340 where computing device 400 may create a task item associated with the actionable item. For example, user device 110 may create a reminder for the user to schedule the meeting.

Method 300 may then advance to stage 315 where computing device 400 may display the task item to the user on the user device. For example, user interface 200 may be displayed to the user on display 115. Consistent with embodiments of the invention, the task item may be created upon receiving the user's input at 310 and displayed to the user immediately. The processing of the input described by stages 315-335 may then be performed in the background and/or at a later time, such as when the user next accesses their task list. Method 300 may then end at stage 350.

An embodiment consistent with the invention may comprise a system for providing task list linking. The system may comprise a memory storage and a processing unit coupled to the memory storage. The processing unit may be operative to receive an input from a user, translate the input into at least one actionable item, and link the at least one actionable item to a data source.

Another embodiment consistent with the invention may comprise a system for providing task list linking. The system may comprise a memory storage and a processing unit coupled to the memory storage. The processing unit may be operative to receive an input comprising a plurality of elements from a user, translate the input into at least one intent, map at least one element of the plurality of elements to a data source, and create a task item associated with the at least one intent, wherein the task item comprises a link to the data source mapped to the at least one element.

Yet another embodiment consistent with the invention may comprise a system for providing task list linking. The system may comprise a memory storage and a processing unit coupled to the memory storage. The processing unit may be operative to receive a spoken input from a user associated with a user device, identify at least one intent associated with the spoken input, wherein identifying the at least one intent comprises performing a semantic parse of the spoken input to identify a domain associated with the spoken input and at least one semantic slot associated with the domain, translate the input into at least one actionable item associated with the identified intent, wherein the at least one actionable item comprises a plurality of elements, populate at least one first element of the plurality of elements of the at least one actionable item according to the identified at least one semantic slot, compare each of the plurality of elements of the input to each of a plurality of properties associated with a plurality of external data sources, link at least one second element of the plurality of elements of the at least one actionable item to at least one of the plurality of properties associated with the plurality of external data sources, wherein the plurality of external data sources comprise at least one of the following: a network data source, a user profile, a website, a contact, an address, and a meeting event, create a task item associated with the at least one actionable item wherein the task item comprises a hyperlink to at least one of the plurality of properties associated with the plurality of external data sources, and display the task item to the user on the user device.

The embodiments and functionalities described herein may operate via a multitude of computing systems, including wired and wireless computing systems, mobile computing systems (e.g., mobile telephones, tablet or slate type computers, laptop computers, etc.). In addition, the embodiments and functionalities described herein may operate over distributed systems, where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which embodiments of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like. FIG. 4 and the associated descriptions provide a discussion of a variety of operating environments in which embodiments of the invention may be practiced. However, the devices and systems illustrated and discussed with respect to FIG. 3 are for purposes of example and illustration and are not limiting of a vast number of computing device configurations that may be utilized for practicing embodiments of the invention, described herein.

With reference to FIG. 4, a system consistent with an embodiment of the invention may include a computing device, such as computing device 400. In a basic configuration, computing device 400 may include at least one processing unit 402 and a system memory 404. Depending on the configuration and type of computing device, system memory 404 may comprise, but is not limited to, volatile (e.g. random access memory (RAM)), non-volatile (e.g. read-only memory (ROM)), flash memory, or any combination. System memory 404 may include operating system 405, one or more programming modules 406, and may comprise speech recognizer 130. Operating system 405, for example, may be suitable for controlling computing device 400's operation. Furthermore, embodiments of the invention may be practiced in conjunction with a graphics library, other operating systems, or any other application program and is not limited to any particular application or system. This basic configuration is illustrated in FIG. 4 by those components within a dashed line 408.

Computing device 400 may have additional features or functionality. For example, computing device 400 may also include additional data storage devices (removable and/or non-removable) such as, for example, magnetic disks, optical disks, or tape. Such additional storage is illustrated in FIG. 4 by a removable storage 409 and a non-removable storage 410. Computing device 400 may also contain a communication connection 416 that may allow device 400 to communicate with other computing devices 418, such as over a network in a distributed computing environment, for example, an intranet or the Internet. Communication connection 416 is one example of communication media.

The term computer readable media as used herein may include computer storage media. Computer storage media may include volatile and nonvolatile, removable and non-removable media implemented in any method or technology for storage of information, such as computer readable instructions, data structures, program modules, or other data. System memory 404, removable storage 409, and non-removable storage 410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 400. Any such computer storage media may be part of device 400. Computing device 400 may also have input device(s) 412 such as a keyboard, a mouse, a pen, a sound input device, a touch input device, a capture device, etc. A capture device may be operative to record a user and capture spoken words, motions and/or gestures made by the user, such as with a camera and/or microphone. The capture device may comprise any speech and/or motion detection device capable of detecting the speech and/or actions of the user. For example, the capture device may comprise a Microsoft® Kinect® motion capture device comprising a plurality of cameras and a plurality of microphones. Output device(s) 414 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As stated above, a number of program modules and data files may be stored in system memory 404, including operating system 405. While executing on processing unit 402, programming modules 406 may perform processes and/or methods as described above. The aforementioned process is an example, and processing unit 402 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the invention may be practiced via a system-on-a-chip (SOC) where each and/or many of the components illustrated above may be integrated onto a single integrated circuit. Such an SOC device may include one or more processing units, graphics units, communications units, system virtualization units and various application functionalities, all of which may be integrated (or “burned”) onto the chip substrate as a single integrated circuit. When operating via an SOC, the functionality, described herein, with respect to training and/or interacting with any component of operating environment 100 may operate via application-specific logic integrated with other components of the computing device/system on the single integrated circuit (chip).

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicants. The Applicants retain and reserve all rights in the code included herein, and grant permission to reproduce the material only in connection with reproduction of the granted patent and for no other purpose.

While certain embodiments of the invention have been described, other embodiments may exist. While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

We claim:

1. A method for providing task list linking, the method comprising:
receiving an input from a user;
asynchronously translating the input into at least one actionable item; and
linking the at least one actionable item to a data source.

2. The method of claim 1 wherein asynchronously translating the input into the at least one actionable item comprises:
identifying an intent associated with the input; and
providing at least one suggested action associated with accomplishing the intent.

3. The method of claim 1, wherein identifying the intent of the user further comprises:
identifying a plurality of entities associated with the input; and
identifying a context associated with the input.

4. The method of claim 1, wherein asynchronously translating the input into at least one actionable item further comprises:
storing the input at a first time associated with receiving the input; and
translating the input into at least one actionable item at at least one second time.

5. The method of claim 4, wherein asynchronously translating the input into the at least one actionable item further comprises identifying at least one semantic slot associated with the intent of the user.

6. The method of claim 5, wherein linking the at least one actionable item to the data source comprises linking the at least one semantic slot to an element of personal information.

7. The method of claim 1, wherein the input comprises at least one of the following: a text input, a spoken input, and a gesture input and further comprising providing the input to a language understanding service.

8. The method of claim 1, wherein the task list is displayed in a first application separate from the data source.

9. The method of claim 8, wherein the data source comprises at least one of the following: a network data source, a user profile, a website, a contact, an address, and a meeting event.

10. A system for providing task list linking, the system comprising:
a memory storage; and
a processing unit coupled to the memory storage, wherein the processing unit is operable to:
receive an input comprising a plurality of elements from a user,
translate the input into at least one intent,
map at least one element of the plurality of elements to a data source, and
create a task item associated with the at least one intent, wherein the task item comprises a link to the data source mapped to the at least one element.

11. The system of claim 10, wherein the external data element is stored on the memory storage.

12. The system of claim 10, wherein the external data element is stored on a networked storage device.

13. The system of claim 10, wherein being operative to map the at least one element to the data source comprises being operative to perform a similarity comparison between the at least one element and the data source.

14. The system of claim 13, wherein being operative to perform the similarity comparison comprises being operative to compare each of the plurality of elements of the input to each of a plurality of properties associated with a plurality of data sources.

15. The system of claim 10, wherein the input comprises a spoken input.

16. The system of claim 15, wherein the processing unit is further operative to provide the spoken input to a spoken language understanding service.

17. The system of claim 16, wherein being operative to translate the input into at least one intent comprises the processing unit being operative to receive an identified intent from the spoken language understanding service.

18. The system of claim 10, wherein the processing unit is further operative to identify a domain associated with the input.

19. The system of claim 18, wherein the processing unit is further operative to map the at least one element of the plurality of elements to the data source associated with the identified domain.

20. A computer-readable medium which stores a set of instructions which when executed performs a method for providing task list linking, the method executed by the set of instructions comprising:
receiving a spoken input from a user associated with a user device;
identifying at least one intent associated with the spoken input, wherein identifying the at least one intent comprises performing a semantic parse of the spoken input to identify a domain associated with the spoken input and at least one semantic slot associated with the domain;
translating the input into at least one actionable item associated with the identified intent, wherein the at least one actionable item comprises a plurality of elements;
populating at least one element of the plurality of elements of the at least one actionable item according to the identified at least one semantic slot;
comparing each of the plurality of elements of the input to each of a plurality of properties associated with a plurality of external data sources;
linking the at least one element of the plurality of elements of the at least one actionable item to at least one of the plurality of properties associated with the plurality of external data sources, wherein the plurality of external data sources comprise at least one of the following: a network data source, a user profile, a website, a contact, an address, a document, and a meeting event;
creating a task item associated with the at least one actionable item wherein the task item comprises a hyperlink to at least one of the plurality of properties associated with the plurality of external data sources; and
displaying the task item to the user on the user device.
